(19) United States
(12) Patent Application Publication
(10) Pub. No.: US 2024/0262229 A1
(43) Pub. Date: Aug. 8, 2024

(54) PARKING ASSISTANCE DEVICE AND PARKING ASSISTANCE METHOD

(71) Applicant: Panasonic Automotive Systems Co., Ltd., Kanagawa (JP)

(72) Inventors: Takuma IIDA, Kanagawa Ken (JP); Shota AKAURA, Kanagawa Ken (JP)

(73) Assignee: Panasonic Automotive Systems Co., Ltd., Kanagawa (JP)

(21) Appl. No.: 18/637,177

(22) Filed: Apr. 16, 2024

Related U.S. Application Data
(63) Continuation of application No. PCT/JP2022/039586, filed on Oct. 24, 2022.

(30) Foreign Application Priority Data
Dec. 17, 2021 (JP) 2021-204847

(51) Int. Cl. B60L 53/36; B60L 53/12; B60L 53/37; B60L 53/38; B60W 30/06; B60W 50/14; G06T 7/73; G06V 20/56

(52) U.S. Cl. CPC B60L 53/36; B60L 53/12; B60L 53/37; B60L 53/38; B60W 30/06; B60W 50/14; G06T 7/73; G06V 20/56; B60L 2250/16; B60W 2050/146; B60W 2420/403; B60W 2540/215; G06T 2207/30252

(57) ABSTRACT

A parking assistance device according to the present disclosure includes a memory and a processor coupled to the memory. The processor is configured to: record a travel path of a vehicle in teacher traveling by a driver; acquire information related to a position of a contactless power supply device capable of performing contactless power supply to the vehicle; correct the travel path of the vehicle recorded by the teacher traveling by the driver based on the information related to the position of the contactless power supply device; and execute automated traveling of the vehicle based on the corrected travel path.

### CROSS-REFERENCE TO RELATED APPLICATIONS

This application is a continuation of International Application No. PCT/JP2022/039586, filed on Oct. 24, 2022 which claims the benefit of priority of the prior Japanese Patent Application No. 2021-204847, filed on Dec. 17, 2021, the entire contents of which are incorporated herein by reference.

### FIELD

Embodiments described herein relate generally to a parking assistance device and a parking assistance method.

### BACKGROUND

There has been known a parking assistance technique of moving a vehicle by automated driving when parking the vehicle. Such parking assistance includes a home zone parking technique of learning a travel path based on teacher traveling performed by a driver and performing parking assistance by using a result of the learning. The technique is used, for example, in the case of repeatedly performing parking at a predetermined parking position such as a parking lot of a user's home or work.

In addition, there has been known a technique of performing contactless charging from an external power source to an energy storage device mounted on an electric vehicle such as an electric car and a plug-in hybrid car using an electric motor as a traveling drive source. A contactless power supply device that performs contactless power supply to a vehicle is installed in a parking lot of a user's home or office, for example. Conventional technologies are described in JP 6350312 B2, for example.

The present disclosure provides a parking assistance device and a parking assistance method capable of facilitating alignment between a parking position of a vehicle by home zone parking and an installation position of a contactless power supply device.

### SUMMARY

A parking assistance device according to an embodiment of the present disclosure includes a memory and a processor coupled to the memory. The processor is configured to: record a travel path of a vehicle in teacher traveling performed by a driver; acquire information related to a position of a contactless power supply device capable of performing contactless power supply to the vehicle; correct the travel path of the vehicle recorded by the teacher traveling performed by the driver, based on the information related to the position of the contactless power supply device; and execute automated traveling of the vehicle based on the corrected travel path.

### BRIEF DESCRIPTION OF THE DRAWINGS

FIG. 1 is a diagram illustrating an example of a vehicle equipped with a parking assistance device according to a first embodiment;

FIG. 2 is a diagram illustrating an example of a configuration in the vicinity of a driver's seat of the vehicle according to the first embodiment;

FIG. 3 is a diagram illustrating an example of a hardware configuration of the parking assistance device according to the first embodiment;

FIG. 4 is a block diagram illustrating an example of functions provided in the parking assistance device according to the first embodiment;

FIG. 5 is a diagram illustrating an example of a travel path stored by teacher traveling according to the first embodiment;

FIG. 6 is a diagram illustrating an example of a corrected path according to the first embodiment;

FIG. 7 is a diagram illustrating an example of a selection screen displayed on a display device according to the first embodiment;

FIG. 8 is a flowchart illustrating an example of a flow of processing of recording and correcting a travel path, executed by the parking assistance device according to the first embodiment;

FIG. 9 is a view illustrating an example of a selection screen displayed on a display device according to a second embodiment; and

FIG. 10 is a flowchart illustrating an example of a flow of correction processing of a travel path executed by the parking assistance device according to the second embodiment.

### DETAILED DESCRIPTION

Hereinafter, embodiments of a parking assistance device and a parking assistance method according to the present disclosure will be described with reference to the accompanying drawings.

### First Embodiment

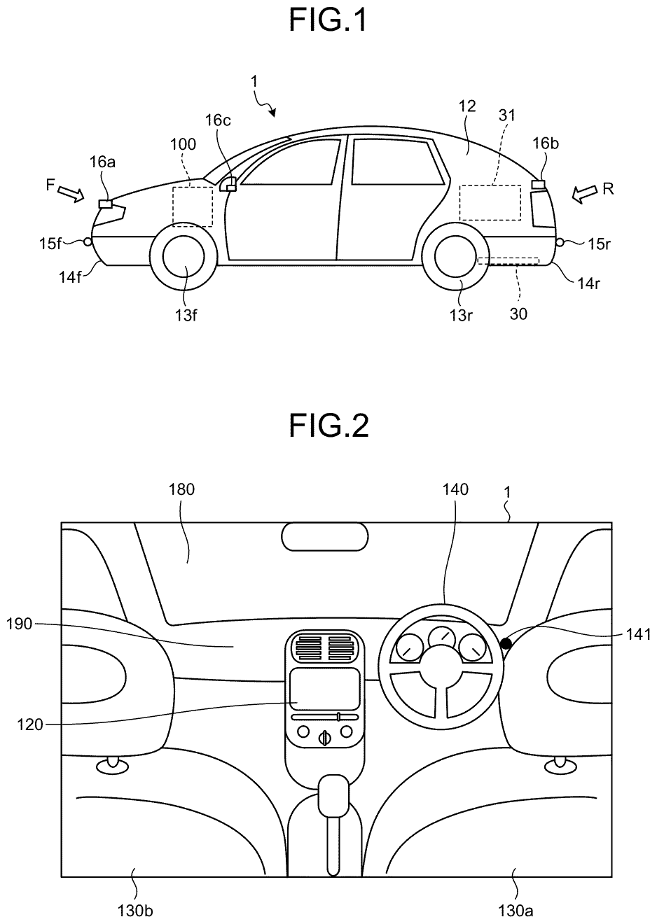

FIG. 1 is a diagram illustrating an example of a vehicle 1 equipped with a parking assistance device 100 according to a first embodiment. As illustrated in FIG. 1, the vehicle 1 includes a vehicle body 12, two pairs of wheels 13 disposed in a predetermined direction on the vehicle body 12, a power receiving device 30, and a battery 31. The two pairs of wheels 13 include a pair of front tires 13f and a pair of rear tires 13r.

The vehicle 1 is an external charging vehicle such as an electric vehicle (EV) or a plug-in hybrid vehicle (PHV) that charges a traveling battery with power supplied from the outside of the vehicle 1.

The battery 31 is a storage battery that stores power for the vehicle 1 to travel.

The power receiving device 30 receives power transmitted from a contactless charging device provided outside the vehicle 1 by the principle of electromagnetic induction, and charges the battery 31. More specifically, the power receiving device 30 includes a power receiving coil that performs contactless power reception from the contactless charging device, and is provided to be exposed to the outside of the vehicle at the bottom of the vehicle 1. The power received by the power receiving device 30 from the contactless charging device is output to the battery 31 as a DC voltage by a power circuit so as to charge the battery 31. The power receiving device 30 and the battery 31 are connected by a cable (not illustrated). The contactless charging device is provided in a parking lot at a location such as the user's home or office.

Note that the vehicle 1 may be able to charge the battery 31 from a plug-in charging device via a charging cable instead of using contactless charging. In this case, the vehicle 1 includes a connector into which a plug of a plug-in charging device can be inserted.

The front tire 13f illustrated in FIG. 1 is an example of a first wheel in the present embodiment. The rear tire 13r is an example of a second wheel in the present embodiment. The two front tires 13f and the two rear tires 13r of the vehicle 1 are collectively referred to as wheels 13. Although the vehicle 1 illustrated in FIG. 1 includes four wheels 13, the number of wheels 13 is not limited thereto. For example, the vehicle 1 may be a two-wheeled vehicle.

The vehicle body 12 is coupled to the wheels 13 and is movable by the wheels 13. In this case, a predetermined direction in which the two pairs of wheels 13 are disposed is the traveling direction of the vehicle 1. The vehicle 1 can travel forward or backward by switching gears (not illustrated) or the like. Moreover, the vehicle 1 can turn right or left by steering.

The vehicle body 12 has a front end F which is an end on the front tire 13f side and a rear end R which is an end on the rear tire 13r side. The vehicle body 12 has a substantially rectangular shape in top view, and four corners of the substantially rectangular shape may be referred to as ends. Although not illustrated in FIG. 1, the vehicle 1 includes a display device, a speaker, a microphone, and an operation unit.

There is provided a pair of bumpers 14 near the lower end of the vehicle body 12 at the front and rear ends F and R of the vehicle body 12. A front bumper 14f of the pair of bumpers 14 covers the entire front surface and a part of the side surface in the vicinity of the lower end of the vehicle body 12. A rear bumper 14r of the pair of bumpers 14 covers the entire rear surface and a part of the side surface in the vicinity of the lower end of the vehicle body 12.

At a predetermined end of the vehicle body 12, there are provided wave transmitters/receivers 15f and 15r, which transmit and receive a sound wave such as an ultrasonic wave. For example, one or more wave transmitters/receivers 15f are disposed on the front bumper 14f, while one or more wave transmitters/receivers 15r are disposed on the rear bumper 14r. Hereinafter, in a case where the wave transmitters/receivers 15f and 15r are not particularly distinguished, the device is simply referred to as a wave transmitter/receiver 15. In addition, the number and positions of the wave transmitters/receivers 15 are not limited to the example illustrated in FIG. 1. For example, the vehicle 1 may include wave transmitters/receivers 15 on the left and right sides.

The present embodiment will describe a sonar using ultrasonic waves an example of the wave transmitter/receiver 15, although the wave transmitter/receiver 15 may be a radar that transmits and receives electromagnetic waves. Alternatively, the vehicle 1 may include both a sonar and a radar. The wave transmitter/receiver 15 may be simply referred to as a sensor.

The wave transmitter/receiver 15 detects an obstacle around the vehicle 1 based on a result of transmission and reception of a sound wave or an electromagnetic wave. In addition, the wave transmitter/receiver 15 measures a distance between the vehicle 1 and an obstacle around the vehicle 1 based on the transmission/reception result of the sound wave or the electromagnetic wave.

In addition, the vehicle 1 includes a first in-vehicle camera 16a that images the front of the vehicle 1, a second in-vehicle camera 16b that images the rear of the vehicle 1, a third in-vehicle camera 16c that images the left side of the vehicle 1, and a fourth in-vehicle camera that images the right side of the vehicle 1. The fourth in-vehicle camera is not illustrated in the figures.

Hereinafter, the first in-vehicle camera 16a, the second in-vehicle camera 16b, the third in-vehicle camera 16c, and the fourth in-vehicle camera will be simply referred to as the in-vehicle camera 16 unless the cameras need to be distinguished. The positions and the number of the in-vehicle cameras are not limited to the example illustrated in FIG. 1. For example, the vehicle 1 may include only two cameras, namely, the first in-vehicle camera 16a and the second in-vehicle camera 16b. Alternatively, the vehicle 1 may further include another in-vehicle camera in addition to the above-described example.

The in-vehicle camera 16 is capable of capturing an image around the vehicle 1, and an example of this is a camera that captures a color image. A captured image, that is, an image captured by the in-vehicle camera 16, may be a moving image or a still image. The in-vehicle camera 16 may be a camera built in the vehicle 1, an on-dash drive recorder camera added to the vehicle 1, or the like.

In addition, the vehicle 1 is equipped with a parking assistance device 100. The parking assistance device 100 is an information processing device that can be mounted on the vehicle 1, and an example of this is an electronic control unit (ECU) or an on board unit (OBU) provided inside the vehicle 1. Alternatively, the parking assistance device 100 may be an external device installed near the dashboard of the vehicle 1. Note that the parking assistance device 100 may also serve as a car navigator or the like.

The parking assistance device 100 according to the present embodiment learns a travel path based on teacher traveling performed by a driver and performs parking assistance using a result of the learning. Such parking assistance is effective for reducing the labor on the driver when performing parking in a case where parking is repeatedly performed at a predetermined parking position such as a garage of the driver's home, a contracted parking position of an apartment building, or a prescribed parking position in a parking lot at a location such as a work place. Such parking assistance is called home zone parking or path storage type automated parking.

In addition to the configuration illustrated in FIG. 1, the vehicle 1 may include various sensors such as a gyro sensor and a wheel speed sensor (not illustrated). The gyro sensor measures a rotational behavior of the vehicle 1, such as movement to front, rear, left, or right, as well as turning. The wheel speed sensor measures a wheel speed of each wheel 13 of the vehicle 1.

Next, a configuration in the vicinity of the driver's seat of the vehicle 1 of the present embodiment will be described. FIG. 2 is a diagram illustrating an example of a configuration in the vicinity of a driver's seat 130a of the vehicle 1 according to the first embodiment.

As illustrated in FIG. 2, the vehicle 1 includes the driver's seat 130a and a passenger seat 130b. In addition, in front of the driver's seat 130a, there are provided a windshield 180, a dashboard 190, a steering wheel 140, a display device 120, and an operation button 141.

The display device 120 is a display provided on the dashboard 190 of the vehicle 1. As an example, the display device 120 is located at the center of the dashboard 190 as illustrated in FIG. 2. The display device 120 is, for example, a liquid crystal display (LCD) or an organic electro luminescence (EL) display. In addition, the display device 120 may also serve as a touch panel. The display device 120 is an example of a display unit in the present embodiment.

The steering wheel 140 is provided in front of the driver's seat 130a and can be operated by the driver. The rotation angle of the steering wheel 140, that is, the steering angle, is electrically or mechanically interlocked with a change in the direction of the front tire 13f, which is a steered wheel. The steered wheels may be the rear tires 13r. Alternatively, both the front tires 13f and the rear tires 13r may be steered wheels.

The operation button 141 is a button capable of receiving an operation by the user. In the present embodiment, an example of the user is the driver of the vehicle 1. The position of the operation button 141 is not limited to the example illustrated in FIG. 2, and may be provided on the steering wheel 140, for example. Although one operation button 141 is illustrated in FIG. 2, the operation button 141 may be provided in plurality. The operation button 141 is an example of an operation unit. Furthermore, in a case where the display device 120 also serves as a touch panel, the display device 120 may be an example of an operation unit.

Next, a hardware configuration of the parking assistance device 100 will be described.

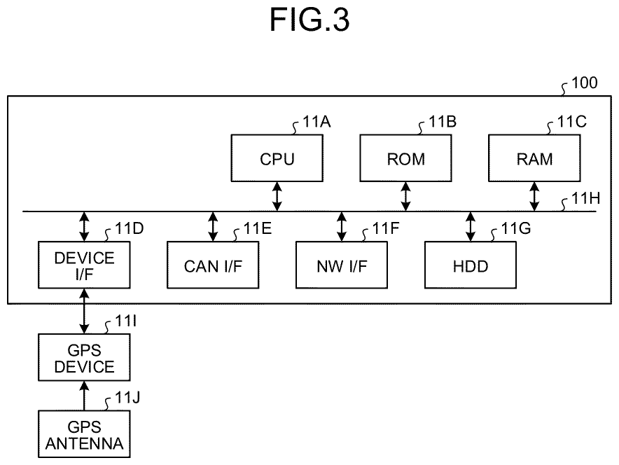

FIG. 3 is a diagram illustrating an example of a hardware configuration of the parking assistance device 100 according to the first embodiment. As illustrated in FIG. 3, the parking assistance device 100 has a configuration in which a central processing unit (CPU) 11A, ROM 11B, RAM 11C, a device interface (Device I/F) 11D, a controller area network (CAN) I/F 11E, a network (NW) I/F 11F, a hard disk drive (HDD) 11G, and the like, are connected to each other via a bus 11H, being a hardware configuration using an ordinary computer.

The CPU 11A is an arithmetic device that performs overall control of the parking assistance device 100. Note that the CPU 11A is an example of a processor in the parking assistance device 100 of the present embodiment, and another processor or a processing circuit may be provided instead of the CPU 11A.

The ROM 11B, the RAM 11C, and the HDD 11G function as storage units. For example, the ROM 11B stores data such as a program that implements various types of processing performed by the CPU 11A. The RAM 11C is a main storage device of the parking assistance device 100, for example, and stores data necessary for various types of processing performed by the CPU 11A.

The device I/F 11D is an interface connectable to various devices. For example, the device I/F 11D is connected to a GPS device 111, and acquires GPS position information indicating the current position of the vehicle 1 from the GPS device 111. The GPS position information is, for example, values of latitude and longitude indicating the absolute position of the vehicle 1.

The GPS device 111 is a device that specifies GPS coordinates representing the position of the vehicle 1 based on a GPS signal received by a GPS antenna 11J. The GPS antenna 11J is an antenna capable of receiving a GPS signal.

The device I/F 11D acquires an image, a detection result, and the like from the in-vehicle camera 16 and the wave transmitter/receiver 15. In addition, the device I/F 11D may acquire measurement results from a gyro sensor and a wheel speed sensor (not illustrated) installed on the vehicle 1.

The CAN I/F 11E is an interface for transmitting and receiving information to and from another ECU installed on the vehicle 1 via a CAN within the vehicle 1. Note that communication standards other than the CAN may be adopted.

The NW I/F 11F is a communication device capable of communicating with a contactless charging device. The NW I/F 11F can communicate with a contactless charging device in the form of communication using a public line such as Long Term Evolution (LTE) (registered trademark), near field communication such as Wi-Fi (registered trademark) or Bluetooth (registered trademark), or the like. Note that the communication format between the contactless charging device and the vehicle 1 is not limited thereto.

Although FIGS. 1 to 3 illustrate the display device 120 as a device separate from the parking assistance device 100, the display device 120 may be included in the parking assistance device 100.

In addition, the parking assistance device 100 may include a speaker and a microphone (not illustrated) in addition to the configuration illustrated in FIG. 3. Alternatively, the device I/F 11D of the parking assistance device 100 may input and output audio data with a speaker and a microphone (not illustrated) provided in the vehicle 1 as a device separate from the parking assistance device 100.

The parking assistance device 100 according to the present embodiment learns a travel path based on teacher traveling performed by a driver and performs parking assistance using a result of the learning. In other words, a parking assistance method executed by the parking assistance device 100 is a method of performing automated traveling of the vehicle 1 based on teacher traveling performed by the driver. Such a parking assistance method is effective for reducing the labor on the driver when performing parking in a case where parking is repeatedly performed at a predetermined parking position such as a garage of the driver's home, a contracted parking position of an apartment building, or a prescribed parking position in a parking lot at a location such as a work place.

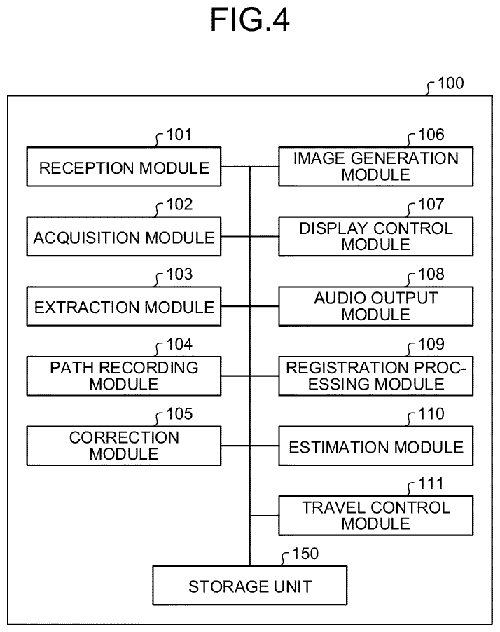

Next, details of the function of the parking assistance device 100 of the present embodiment will be described. FIG. 4 is a block diagram illustrating an example of functions provided in the parking assistance device 100 according to the first embodiment.

As illustrated in FIG. 4, the parking assistance device 100 of the present embodiment includes a reception module 101, an acquisition module 102, an extraction module 103, a path recording module 104, a correction module 105, an image generation module 106, a display control module 107, an audio output module 108, a registration processing module 109, an estimation module 110, a travel control module 111, and a storage unit 150.

The storage unit 150 is constituted with the ROM 11B, the RAM 11C, or the HDD 11G, for example. Although FIG. 4 illustrates that one storage unit 150 is included in the parking assistance device 100, a plurality of storage media may function as the storage unit 150.

The storage unit 150 stores programs and data used in various types of processing executed by the parking assistance device 100. For example, the program executed by the parking assistance device 100 of the present embodiment has a module configuration including the above-described functional units (the reception module 101, the acquisition module 102, the extraction module 103, the path recording module 104, the correction module 105, the image generation module 106, the display control module 107, the audio output module 108, the registration processing module 109, the estimation module 110, and the travel control module 111). Regarding actual hardware, the CPU 11A reads the program from the storage unit 150 and executes the program, thereby loading the above individual units onto the RAM 11C, leading to generation, onto the RAM 11C, of the reception module 101, the acquisition module 102, the extraction module 103, the path recording module 104, the correction module 105, the image generation module 106, the display control module 107, the audio output module 108, the registration processing module 109, the estimation module 110, and the travel control module 111. Note that processing implemented by each functional unit of the parking assistance device 100 is also referred to as a step.

The programs executed by the parking assistance device 100 of the present embodiment are provided as a file in an installable format or an executable format, recorded in a computer readable recording medium such as a flash drive, CD-ROM, a flexible disk (FD), a CD-R, or a Digital Versatile Disk (DVD).

Furthermore, the programs executed on the parking assistance device 100 in the present embodiment may be stored on a computer connected to a network such as the Internet and be provided by downloading via the network. Furthermore, the programs executed on the parking assistance device 100 according to the present embodiment may be provided or distributed via a network such as the Internet. In addition, the programs executed by the parking assistance device 100 according to the present embodiment may be provided by being incorporated beforehand in a medium such as the ROM 11B.

The reception module 101 receives various operations from the user. For example, when the operation button 141 or an image button on the touch panel is pressed, the reception module 101 receives the user's operation of starting and ending the recording of the teacher traveling.

In addition, after the end of the teacher traveling, the reception module 101 receives an operation of the user instructing which one of travel paths are to be registered as a travel path of the teacher traveling, that is, an automated traveling travel path, or a corrected path obtained by correcting the travel path of the teacher traveling by the correction module 105 to be described below.

In addition, for example, when the operation button 141 or an image button on the touch panel is pressed in a state where the travel path has been registered, the reception module 101 receives a parking assistance start operation by the user.

Note that the means used by the reception module 101 to receive the user's operation is not particularly limited. For example, the reception module 101 may receive an operation to start and end the recording of teacher traveling or start parking assistance by a user's voice input from a microphone provided in the vehicle 1.

The acquisition module 102 acquires information related to the position of a contactless power supply device that can perform contactless power supply to the vehicle 1. More specifically, the acquisition module 102 acquires, via the NW I/F 11F, the information related to the position of the contactless power supply device transmitted from the contactless power supply device.

In the present embodiment, the information related to the position of the contactless power supply device is, for example, absolute position information indicating the absolute position of the contactless power supply device. The absolute position information is, for example, information indicating the latitude and longitude of the contactless power supply device.

In addition, the acquisition module 102 acquires, from the plurality of in-vehicle cameras 16a to 16c, a plurality of images around the vehicle 1 captured in time series together with the movement of the vehicle 1. Note that, since the image is an image obtained by capturing the periphery of the vehicle 1, the image is referred to as a surrounding image in the present embodiment.

The acquisition module 102 also acquires information related to a distance between the vehicle and an object around the vehicle 1. The information related to the distance between the object around the vehicle 1 and the vehicle include the presence or absence of an obstacle detected by the wave transmitter/receiver 15 and the length of the distance between the detected obstacle around the vehicle 1 and the vehicle 1. The presence or absence of the obstacle detected by the wave transmitter/receiver 15, the distance between the vehicle 1 and the obstacle around the vehicle 1 measured by the wave transmitter/receiver 15, and the surrounding image may be referred to as environmental information regarding the environment around the vehicle 1. Note that the environmental information is not limited to these pieces of information.

In addition, the acquisition module 102 acquires GPS position information from the GPS device 111 via the device I/F 11D.

In addition, the acquisition module 102 acquires vehicle information regarding the vehicle 1 from various sensors or other ECUs on the vehicle 1. The vehicle information includes, for example, information related to a speed, a steering angle, and a braking operation of the vehicle 1. Each piece of information included in the vehicle information of the vehicle 1 is stored in the storage unit 150 in association with the time of detection of each piece of information. The vehicle information regarding the vehicle 1 may further include information such as a wheel speed, a rotation speed of the wheels 13, acceleration of the vehicle 1 measured by a gyro sensor or the like.

The extraction module 103 extracts feature points around the vehicle 1 from a surrounding image obtained by capturing the periphery of the vehicle 1 captured by the in-vehicle camera 16 or a result of sensing the periphery of the vehicle 1 by the wave transmitter/receiver 15. The method of extracting feature points by the extraction module 103 is not particularly limited, and a known method may be applied. For example, the extraction module 103 extracts feature points by using a method such as Features from Accelerated Segment Test (FAST) or Oriented FAST and Rotated BRIEF (ORB). Furthermore, at the time of learning of a travel path 80, the extraction module 103 may preferentially record a feature point that satisfies a prescribed condition among the extracted feature points. For example, among a plurality of surrounding images continuous in time series, it is allowable to preferentially select, as a feature point, a feature point extracted from a surrounding image including a longer traveling distance of the vehicle 1 during imaging.

The path recording module 104 records the travel path of the vehicle 1 in the teacher traveling performed by the driver. The path recording module 104 estimates the position of the vehicle 1 during the teacher traveling based on a change in the feature point extracted by the extraction module 103 and based on vehicle information regarding the vehicle 1, and specifies the travel path based on the time-series change in the position.

More specifically, the path recording module 104 specifies a change in the position of the vehicle 1 based on a time-series change in feature points extracted from a plurality of surrounding images captured during teacher traveling. In addition, the path recording module 104 may correct the position of the vehicle 1 specified from the feature point, based on the acquired vehicle information. Alternatively, the path recording module 104 may estimate the position of the vehicle 1 during the teacher traveling from a change in the absolute position of the vehicle 1 based on the GPS position information of the vehicle 1.

In the present embodiment, information in which a travel path for automated traveling, a speed, a steering angle, and a braking operation of the vehicle 1 traveling on the travel path, and feature points extracted from a plurality of surrounding images captured together with the movement of the vehicle 1 during teacher traveling, are associated in time series, is referred to as travel path information. Since the travel path of the vehicle 1 is defined by the travel path information, the processing of collecting the travel path information is recording processing of the travel path of the vehicle 1. The path recording module 104 stores the travel path information in the storage unit 150. Either the travel path information or corrected path information obtained by correcting the travel path information by the correction module 105 to be described below is used by the travel control module 111 during automated traveling to be described below. Note that the recording method of the travel path and the definition of the travel path information are not limited to the example.

In addition, the path recording module 104 defines the environment around the vehicle 1 as map information based on feature points extracted from the surrounding image captured during the teacher traveling, and stores the map information in the storage unit 150. Note that the recording processing of the travel path based on the teacher traveling may be referred to as learning processing.

The correction module 105 corrects the travel path of the vehicle 1 recorded by the teacher traveling performed by the driver based on the information related to the position of the contactless power supply device acquired by the acquisition module 102. More specifically, when the power receiving device 30 of the vehicle 1 is separated from a contactless power supply device 50 by more than a threshold at a parking position in the travel path in the teacher traveling recorded by the path recording module 104, the correction module 105 corrects the travel path so that the distance between the power receiving device 30 of the vehicle 1 and the contactless power supply device 50 at the parking position is the threshold or less. In the present embodiment, the travel path after correction is referred to as a corrected path.

For example, the correction module 105 obtains the relative position between the vehicle 1 and the contactless power supply device 50 at the parking position based on the absolute position of the vehicle 1 at the parking position of the travel path recorded by the path recording module 104 and the absolute position of the contactless power supply device acquired by the acquisition module 102. Based on the relative position, the correction module 105 calculates a distance between the vehicle 1 and contactless power supply device 50 at the parking position. When the calculated distance is more than the threshold, the correction module 105 obtains a correction amount that can correct the distance between the power receiving device 30 of the vehicle 1 and the contactless power supply device 50 to be the threshold or less, and sets a result of reflecting the obtained correction amount on the recorded travel path, as a corrected path. A path correction method is not particularly limited.

The reference of the distance between the vehicle 1 and the contactless power supply device 50 at the parking position is not limited to the absolute position of the vehicle 1 or the absolute position of the contactless power supply device acquired by the acquisition module 102.

The position at which the distance between the power receiving device 30 of the vehicle 1 and the contactless power supply device 50 is shortest is a position at the time when the power receiving device 30 of the vehicle 1 is located above the contactless power supply device 50, and this position is an ideal position for charging. However, the position does not necessarily have to be the ideal position, and the vehicle 1 is only required to be parked at a position where the distance between the power receiving device 30 and the contactless power supply device 50 is a distance at which the prescribed charging efficiency is maintained. In the present embodiment, the prescribed charging efficiency is supposed to be maintained when the distance between the power receiving device 30 and the contactless power supply device 50 of the vehicle 1 is the threshold or less. The threshold is not particularly limited, and varies depending on the device characteristics of the power receiving device 30 and the contactless power supply device.

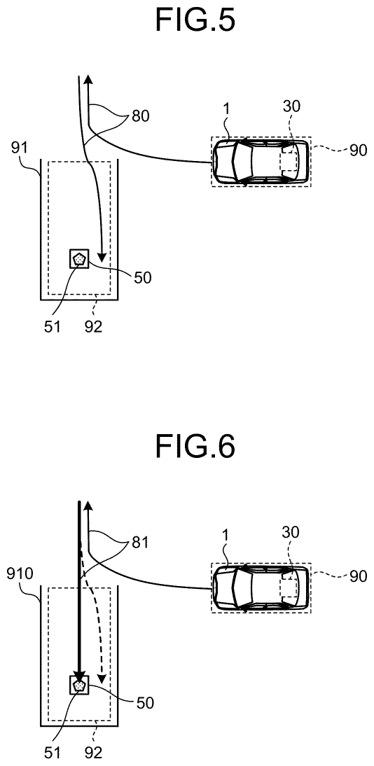

Here, a travel path before and after correction will be described with reference to FIGS. 5 and 6.

FIG. 5 is a diagram illustrating an example of the travel path 80 stored by teacher traveling according to the first embodiment. The travel path 80 is a path on which the vehicle 1 has traveled from a start position 90 of the teacher traveling to a parking region 92 in a parking frame 91.

The parking frame 91 may be a division line defining a parking region, or may be a structure defining the parking region 92. The parking frame 91 is, for example, a parking frame provided in a parking lot located at a place such as the user's home or office, but the installation location of the parking frame 91 is not limited thereto. In addition, even when the parking frame 91 is not explicitly provided, it is only required to have a space of a size that allows the vehicle 1 to be parked.

The parking region 92 is a range in which the vehicle 1 can be parked within the parking frame 91.

As illustrated in FIG. 5, the contactless power supply device 50 is located in the parking region 92 of the present embodiment.

The contactless power supply device 50 includes a power transmission coil that performs contactless power transmission. The contactless power supply device 50 is provided on the ground of the parking frame 91 at a height lower than the bottom of the vehicle 1. In addition, the contactless power supply device 50 includes a communication device, and performs wireless communication with the parking assistance device 100 of the vehicle 1 located within a communication range. The contactless power supply device 50 can communicate with a contactless charging device in the form of communication using a public line such as Long Term Evolution (LTE) (registered trademark), near field communication such as Wi-Fi (registered trademark) or Bluetooth (registered trademark), or the like. Note that the communication format between the contactless power supply device 50 and the vehicle 1 is not limited thereto.

A mark 51 indicating the contactless power supply device 50 may be attached to the surface of the contactless power supply device 50. Note that the shape of the contactless power supply device 50 and a display mode of the mark 51 are not limited to the example illustrated in FIG. 5. The contactless power supply device 50 need not necessarily include the mark 51.

When the vehicle 1 is parked in the parking region 92, the closer the distance between the power receiving device 30 of the vehicle 1 and the contactless power supply device 50, the higher the charging efficiency from the contactless power supply device 50 to the power receiving device 30.

However, since the driver manually drives the vehicle 1 in the teacher traveling, the distance between the power receiving device 30 of the vehicle 1 and the contactless power supply device 50 might be longer than a threshold when the power receiving device 30 of the vehicle 1 is parked in the parking region 92. In the example illustrated in FIG. 5, the parking position of the vehicle 1 is supposed to be deviated from the position ideal for charging in the travel path of the vehicle 1 in the teacher traveling, making the distance between the power receiving device 30 and the contactless power supply device 50 of the vehicle 1 longer than the threshold.

FIG. 6 is a diagram illustrating an example of a corrected path 81 according to the first embodiment. In the corrected path 81 illustrated in FIG. 6, the distance between the power receiving device 30 and the contactless power supply device 50 of the vehicle 1 at the parking position is shorter than the distance in the travel path 80 illustrated in FIG. 5. Therefore, the charging efficiency from the contactless power supply device 50 to the power receiving device 30 is improved when the vehicle 1 is parked using the corrected path 81 as compared with the case where the vehicle 1 is parked using the travel path 80 before the correction.

In the present embodiment, after the end of the teacher traveling, the correction module 105 corrects the travel path 80 recorded by the path recording module 104 based on the information related to the position of the contactless power supply device 50, and stores the corrected path 81 in the storage unit 150. Note that the correction module 105 stores the corrected path 81 in the storage unit 150 when the user has selected the corrected path 81 on the selection screen to be described below. When the user has not selected the corrected path 81 on the selection screen to be described below, the correction module 105 does not store the corrected path 81 in the storage unit 150.

Returning to FIG. 4, based on the travel path 80 recorded by the path recording module 104, the image generation module 106 generates a travel path image representing the travel path 80. In addition, the image generation module 106 generates a corrected path image representing the corrected path 81 based on the corrected path 81 corrected by the correction module 105.

The travel path image is, for example, an image representing a path from a start position 90 to an end position of the travel path 80 by using a line. In addition, the corrected path image is, for example, an image representing a path from the start position 90 to the end position of the corrected path 81 by using a line. In the travel path image and the corrected path image, for example, the travel path 80 is illustrated with reference to the moving locus of the center of the vehicle body 12 of the vehicle 1. In addition, the leading ends of the lines representing the travel path image and the corrected path image are supposed to have arrow shapes indicating the traveling direction of the vehicle 1. Note that the mode of the travel path image is not limited thereto.

The image generation module 106 also generates a background image depicting the parking frame 91, the parking region 92, and the contactless power supply device 50. The image generation module 106 may generate the background image based on a surrounding image obtained by capturing the periphery of the vehicle by the in-vehicle camera 16, for example. The background image is, for example, an overhead view image being a top view of a range including the travel path 80, but is not limited thereto. In the present embodiment, the image generation module 106 generates a first overhead view image in which the travel path image is superimposed on the background image and a second overhead view image in which the corrected path image is superimposed on the background image.

Note that the image generation module 106 may include both the travel path image and the corrected path image in one overhead view image. In this case, display modes such as colors of the travel path image and the corrected path image are supposed to be varied so that the user can distinguish the travel path image and the corrected path image from each other.

The display control module 107 causes the display device 120 to display a selection screen on which the user can select whether to correct the travel path 80 recorded by the teacher traveling based on the information related to the position of the contactless power supply device 50.

The audio output module 108 causes a speaker provided in the vehicle 1 to output sound or voice.

In addition, the registration processing module 109 stores the path selected by the user, from among the travel path 80 and the corrected path 81, in the storage unit 150. In the present embodiment, storing the travel path 80 or the corrected path 81 in the storage unit 150 is referred to as registering the travel path 80 or the corrected path 81.

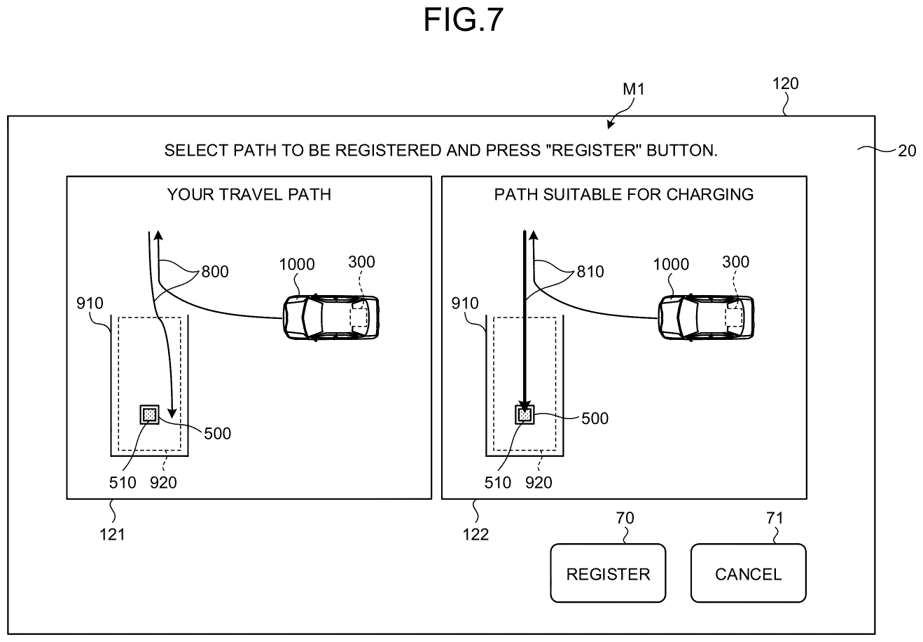

FIG. 7 is a diagram illustrating an example of a selection screen 20 displayed on the display device 120 according to the first embodiment. In the example illustrated in FIG. 7, the display device 120 is supposed to be functioning as a touch panel. Therefore, the operation performed by the user on the selection screen 20 is received by the reception module 101.

For example, as illustrated in FIG. 7, the selection screen 20 includes a first overhead view image 121, a second overhead view image 122, a message M1 prompting the user to perform an operation, a registration button 70, and a cancel button 71.

The first overhead view image 121 is an image in which a travel path image 800 indicating the travel path 80 of teacher traveling is superimposed on a background image. The second overhead view image 122 is an image in which a corrected path image 810 indicating the corrected path 81 is superimposed on the background image. In the example illustrated in FIG. 7, the first overhead view image 121 and the second overhead view image 122 each include a parking frame image 910 representing the parking frame 91, a parking region image 920 representing the parking region 92, and a contactless power supply device image 500 representing the contactless power supply device 50. It is also allowable to display a mark image 510 representing the mark 51 in the contactless power supply device image 500. In addition, in the example illustrated in FIG. 7, the first overhead view image 121 and the second overhead view image 122 each further include a vehicle image 1000 indicating the vehicle 1. The vehicle image 1000 is displayed at a position corresponding to the travel path 80 and the start position 90 of the corrected path 81, for example. In addition, a power receiving device image 300 representing the power receiving device 30 is displayed in the vehicle image 1000.

To facilitate understanding for the user, the display control module 107 may describe “Your travel path” on the first overhead view image 121, and “Path suitable for charging” on the second overhead view image 122, and the like.

The message M1 prompts the user to perform an operation of selecting either the travel path 80 or the corrected path 81 as a registration target. FIG. 7 illustrates an example of the message M1 “Select path to be registered and press [Register] button.” but the message M1 is not to be limited to this example. Further, the message M1 may be output by voice by the audio output module 108.

The registration button 70 and the cancel button 71 are image buttons by which the user can input an operation. The registration button 70 enables input of a user's operation of selecting either the travel path 80 or the corrected path 81 and then determining the selected travel path as a registration target. In the example illustrated in FIG. 7, the first overhead view image 121 and the second overhead view image 122 function as image buttons. When the user presses the first overhead view image 121 or the second overhead view image 122, the reception module 101 receives an operation of selecting a path corresponding to the pressed overhead view image.

For example, when the user has pressed the registration button 70 after pressing the first overhead view image 121, the reception module 101 receives an operation of the user to determine the travel path 80 as a registration target. In this case, the registration processing module 109 stores the travel path 80 in the storage unit 150. When the user presses the registration button 70 after pressing the second overhead view image 122, the reception module 101 receives an operation of the user to determine the corrected path 81 as the registration target. In this case, the registration processing module 109 stores the corrected path 81 in the storage unit 150.

The cancel button 71 is an image button by which the user can input an operation of canceling the registration processing of the travel path 80 based on the teacher traveling and the corrected path 81. When the user presses the cancel button 71, the reception module 101 receives a cancel operation by the user. In this case, the registration processing module 109 stores neither the travel path 80 nor the corrected path 81.

Note that the display mode of the selection screen 20 illustrated in FIG. 7 is an example, and is not limited to this example. In addition, the user's operation of registering the travel path 80 of the teacher traveling, the operation of registering the corrected path 81 and cancel operations may be input from a physical button such as the operation button 141 instead of the image button on the touch panel.

In addition, the parking assistance device 100 may prompt the user to perform an operation of registering the travel path 80 of the teacher traveling, an operation of registering the corrected path 81 and cancel operations by voice guidance instead of displaying the selection screen 20. For example, the audio output module 108 may output a voice that asks the user which of the travel path 80 and the corrected path 81 to select or cancel. In this case, the reception module 101 receives the operation of registering the travel path 80, the operation of registering the corrected path 81 and cancel operations by the user's voice.

Returning to FIG. 4, when the vehicle 1 performs automated traveling based on the travel path 80 or the corrected path 81 by the travel control module 111 described below, the estimation module 110 estimates the position and orientation of the vehicle 1 based on the surrounding image.

For example, the estimation module 110 estimates the position of the vehicle 1 by comparing the feature point of the surrounding image captured by the in-vehicle camera 16 during the teacher traveling with the feature point of the current surrounding image. The method of estimating the position and the orientation of the vehicle 1 by the estimation module 110 is not limited to this example. The estimation module 110 may correct the estimated position of vehicle 1 on the basis of the absolute position of vehicle 1 based on the GPS position information of the vehicle 1.

The travel control module 111 controls to move the vehicle 1 to the parking region 92 within the parking frame 91 by automated driving based on the travel path 80 or the corrected path 81. For example, in a case where the corrected path 81 is selected as a registration target by the user, the travel control module 111 executes automated traveling of the vehicle 1 based on the corrected path 81 when executing parking assistance. The travel control module 111 controls steering, braking, and acceleration/deceleration of the vehicle 1 to allow the vehicle 1 to perform automated traveling along the registered travel path 80 or the corrected path 81. Such a travel control method is also referred to as reproducing the travel path 80 or the corrected path 81.

In addition, the travel control module 111 may control to allow the vehicle 1 to perform an operation different from the teacher traveling, based on the vehicle information and the environmental information of the vehicle 1 acquired by the acquisition module 102 during the automated traveling. As described above, the environmental information includes the presence or absence of the obstacle around the vehicle 1 and the distance between the obstacle and the vehicle 1 around the vehicle 1. For example, when an obstacle such as another vehicle approaches during automated driving, the travel control module 111 executes control such as stopping the vehicle 1.

During the automated traveling by the travel control module 111, the driver may be seated on the driver's seat 130a of the vehicle 1 or may be outside the vehicle 1.

In addition, when the vehicle 1 deviates from the travel path 80 or the corrected path 81 during automated traveling, the travel control module 111 may perform feedback control to move the vehicle 1 so as to return to the travel path 80 or the corrected path 81. For example, the travel control module 111 specifies a difference between the position of the vehicle 1 estimated by the estimation module 110 and the travel path 80 or the corrected path 81, and controls the vehicle 1 to travel so as to reduce the difference.

In FIG. 4, the parking assistance device 100 includes the travel control module 111. However, the travel control module 111 may be implemented by another ECU different from the parking assistance device 100.

Next, a flow of correction processing of the travel path 80 executed by the parking assistance device 100 of the present embodiment configured as described above will be described. In the present embodiment, the correction of the travel path 80 is performed after recording of the travel path 80 used by teacher traveling.

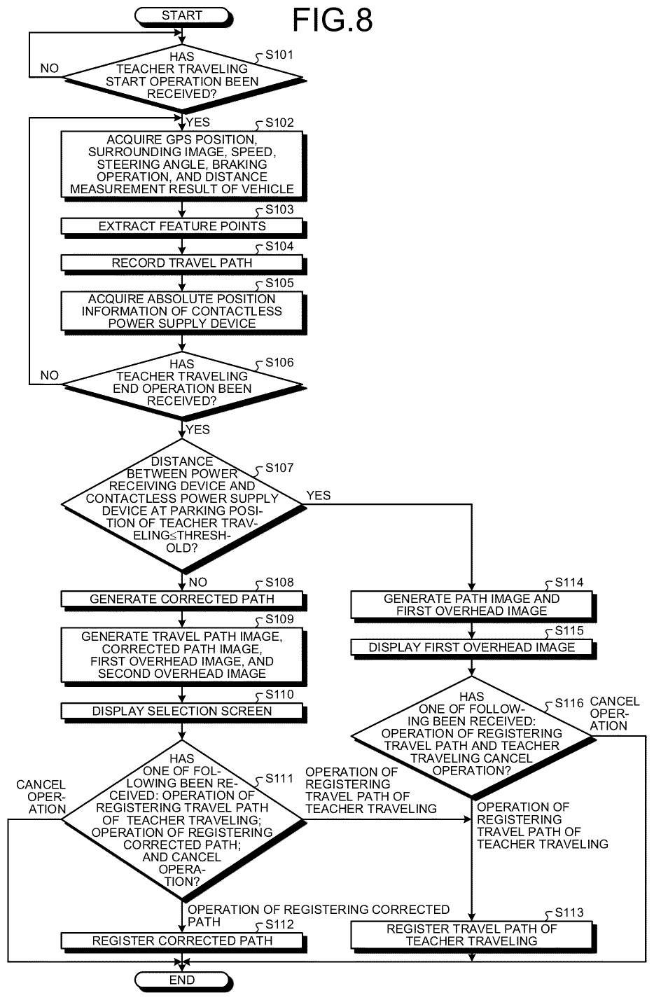

FIG. 8 is a flowchart illustrating an example of a flow of processing of recording and correcting the travel path 80, executed by the parking assistance device 100 according to the first embodiment.

First, the reception module 101 determines whether a teacher traveling start operation by the user has been received (S101). When the teacher traveling start operation by the user has not been received (S101 “No”), the reception module 101 repeats the processing of S101 and waits.

When the reception module 101 has received the teacher traveling start operation by the user (S101 “Yes”), the processing of recording the teacher traveling is started. After performing the teacher traveling start operation, the driver moves the vehicle 1 by manual traveling to the parking region 92.

Subsequently, during the teacher traveling by the driver, the acquisition module 102 acquires GPS position information from the GPS device 111. In addition, the acquisition module 102 acquires surrounding images from the plurality of in-vehicle cameras 16a to 16c. Furthermore, the acquisition module 102 acquires the speed, the steering angle, and the braking operation of the vehicle 1 from various sensors or another ECU of the vehicle 1. In addition, the acquisition module 102 acquires a distance measurement result regarding a distance between the vehicle 1 and a surrounding obstacle from the wave transmitter/receiver 15 (S102).

Subsequently, the extraction module 103 extracts feature points from the plurality of surrounding images acquired (S103).

Subsequently, the path recording module 104 estimates the position of the vehicle 1 during the teacher traveling based on a change in the feature point extracted from the plurality of surrounding images, the speed, the steering angle, the braking operation, the distance measurement result, and the GPS position information, and records the time-series change of the position as the travel path 80 (S104).

In addition, during the teacher traveling, the acquisition module 102 acquires information related to the position of the contactless power supply device 50. In the present embodiment, the acquisition module 102 acquires absolute position information of the contactless power supply device 50 during the teacher traveling (S105).

Subsequently, the reception module 101 determines whether a teacher traveling end operation has been received (S106). When the teacher traveling end operation by the user has not been received (S106 “No”), the reception module 101 repeats the processing of S102 to S106.

When the reception module 101 has received the teacher traveling end operation by the user (S106 “Yes”), the correction module 105 determines whether the distance between the power receiving device 30 and the contactless power supply device 50 at the parking position of the teacher traveling is a threshold or less (S107).

When the distance between the power receiving device 30 and the contactless power supply device 50 at the parking position of the teacher traveling is longer than the threshold (S107 “No”), the correction module 105 corrects the travel path 80 so that the distance between the power receiving device 30 and the contactless power supply device 50 of the vehicle 1 at the parking position is the threshold or less, thereby generating the corrected path 81 (S108).

Subsequently, the image generation module 106 generates the travel path image 800, the corrected path image 810, the first overhead view image 121, and the second overhead view image 122 (S109).

Subsequently, the display control module 107 causes the display device 120 to display the selection screen 20 (S110).

Subsequently, when the reception module 101 has received the operation of registering the corrected path 81 by the user on the selection screen 20 (S111 “Operation of registering corrected path”), the registration processing module 109 registers the corrected path 81 (S112).

When the reception module 101 has received the user's operation of registering the travel path 80 of the teacher traveling on the selection screen 20 (S111 “Operation of registering travel path of teacher traveling”), the registration processing module 109 registers the travel path 80 of the teacher traveling (S113). For example, in a case where the user intentionally trains the vehicle 1 to learn a travel path of parking the vehicle 1 at a position away from the contactless power supply device 50, the user performs an operation of registering the travel path 80 of teacher traveling. As an example, there is a case where the user performs teacher traveling by prioritizing parking the vehicle 1 at a convenient position at the time of getting off or on the vehicle rather than charging efficiency.

When the reception module 101 has received a cancel operation by the user on the selection screen 20 (S111 “Cancel operation”), the registration processing module 109 does not register the travel path 80 or the corrected path 81. For example, the user can perform cancel operation in a case where the user desires to redo the teacher traveling. In this case, the user may use the cancel operation to perform, after finishing the processing of the flowchart, movement of the vehicle 1 to the start position 90 again by manual driving and then perform the teacher traveling start operation. When the user performs the teacher traveling start operation, the processing is executed again from S101.

When the distance between the power receiving device 30 and the contactless power supply device 50 at the parking position for the teacher traveling is the threshold or less (S107 “Yes”), the correction module 105 does not correct the travel path 80. In this case, the image generation module 106 generates the travel path image 800 and the first overhead view image 121 (S114).

Subsequently, the display control module 107 causes the display device 120 to display the first overhead view image 121 (S115). The screen displaying the first overhead view image 121 is referred to as a confirmation screen. The confirmation screen includes a registration button 70 and a cancel button 71, for example, similarly to the selection screen 20. The confirmation screen can receive user's operation of registering the travel path 80 or operation of canceling the teacher traveling. When the reception module 101 has received the operation of registering the travel path 80 of the teacher traveling on the confirmation screen (S116 “Operation of registering travel path of teacher traveling”), the registration processing module 109 registers the travel path 80 of the teacher traveling (S113).

When the reception module 101 has received the user's cancel operation on the registration screen (S116 “Cancel operation”), the registration processing module 109 does not register the travel path 80. Here, the processing of this flowchart ends.

In this manner, the parking assistance device 100 of the present embodiment acquires information related to the position of the contactless power supply device 50 and corrects the travel path 80 of the vehicle 1 recorded by the teacher traveling based on the acquired information related to the position of the contactless power supply device 50. Therefore, according to the parking assistance device 100 of the present embodiment, it is possible to generate the corrected path 81 that allows the vehicle 1 to be parked at the parking position corresponding to the position of the contactless power supply device 50 without the driver's repeated trial and error on the teacher traveling to park the vehicle 1 at an ideal position for charging. With such a configuration, the parking assistance device 100 of the present embodiment makes it possible to facilitate alignment between the parking position of the vehicle 1 by home zone parking and the installation position of the contactless power supply device 50.

In a technique, as a comparative example, in which a vehicle having a contactless charging function generates a parking path at the time of parking without using teacher traveling, path generation is performed such that the power receiving device of the vehicle and the contactless power supply device installed in the parking lot are aligned every time parking assistance is performed. Therefore, it is necessary to use a large number of sensors, and the system tends to be complicated. In addition, when the correction according to the position of the contactless power supply device is not performed in the use of the home zone parking technology, there is a possibility that the driver needs to execute teacher traveling many times until the vehicle is parked at an ideal position for charging. In contrast, according to the parking assistance device 100 of the present embodiment, it is possible, as described above, to generate the corrected path 81 that allows the vehicle 1 to be parked at the parking position corresponding to the position of the contactless power supply device 50 without the driver's repeated trial and error on the teacher traveling to park the vehicle 1 at the ideal position for charging.

In the parking assistance device 100 of the present embodiment, absolute position information indicating the absolute position of the contactless power supply device 50 is received from the contactless power supply device 50. Therefore, according to the parking assistance device 100 of the present embodiment, the travel path 80 can be easily corrected to achieve matching between the absolute position information and the position of the power receiving device 30 of the vehicle 1.

In addition, according to the parking assistance device 100 of the present embodiment, when the power receiving device 30 of the vehicle 1 is separated from the contactless power supply device 50 by more than a threshold at a parking position in the travel path 80 in the teacher traveling, the travel path 80 is corrected so that the distance between the power receiving device 30 of the vehicle 1 and the contactless power supply device 50 at the parking position is the threshold or less. Therefore, according to the parking assistance device 100 of the present embodiment, the vehicle 1 can be parked at a position where the prescribed charging efficiency is maintained.

In addition, the parking assistance device 100 of the present embodiment causes the display device 120 to display the selection screen 20 on which the user can select whether to correct the travel path 80 based on the information related to the position of the contactless power supply device 50. Therefore, according to the parking assistance device 100 of the present embodiment, it is possible to avoid correction against the user's intention in a case where the user intentionally parks at a position away from the contactless power supply device 50.

### Second Embodiment

In the first embodiment described above, the parking assistance device 100 corrects the travel path 80 after the teacher traveling and registers the corrected travel path 80. In the second embodiment, the parking assistance device 100 corrects the travel path 80 at the time of parking assistance.

The vehicle 1 of the present embodiment has a configuration similar to the case of the first embodiment described with reference to FIGS. 1 and 2. The hardware configuration of the parking assistance device 100 of the present embodiment is similar to the case of the first embodiment described with reference to FIG. 3.

Similarly to the first embodiment, the parking assistance device 100 of the present embodiment includes the reception module 101, the acquisition module 102, the extraction module 103, the path recording module 104, the correction module 105, the image generation module 106, the display control module 107, the audio output module 108, the registration processing module 109, the estimation module 110, the travel control module 111, and a storage unit 150. The reception module 101, the extraction module 103, the path recording module 104, the image generation module 106, the audio output module 108, the registration processing module 109, the estimation module 110, the travel control module 111, and the storage unit 150 have functions similar to the case of the first embodiment.

In the present embodiment, the travel path 80 recorded in the teacher traveling is stored, without being corrected, in the storage unit 150 by the path recording module 104.

With functions similar to the case of the first embodiment, the acquisition module 102 of the present embodiment acquires information related to the position of the contactless power supply device 50 from the contactless power supply device 50 before the travel control module 111 starts automated traveling of the vehicle 1.

With functions similar to the case of the first embodiment, the correction module 105 of the present embodiment corrects, before the start of the automated traveling of the vehicle 1, the travel path 80 stored in the storage unit 150 based on the information related to the position of the contactless power supply device 50.

With functions similar to the case of the first embodiment, the display control module 107 of the present embodiment causes, before the start of the automated traveling of the vehicle 1, the display device 120 to display a selection screen on which the user can select whether to correct the travel path 80 recorded by the teacher traveling based on the information related to the position of the contactless power supply device 50.

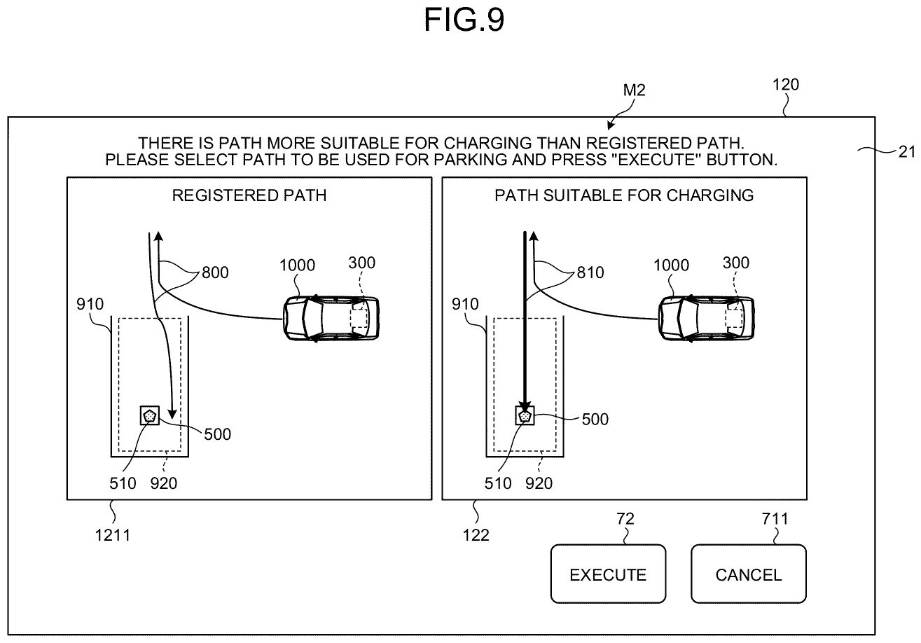

FIG. 9 is a view illustrating an example of a selection screen 21 displayed on the display device 120 according to the second embodiment. For example, as illustrated in FIG. 9, the selection screen 21 includes a first overhead view image 1211, a second overhead view image 122, a message M2 prompting the user to perform an operation, an execution button 72, and a cancel button 711.

Similarly to the first embodiment, the first overhead view image 1211 of the present embodiment is an image in which a travel path image 800 indicating the travel path 80 of teacher traveling is superimposed on a background image. Similarly to the first embodiment, the second overhead view image 122 is an image in which a corrected path image 810 indicating the corrected path 81 is superimposed on the background image. To facilitate understanding for the user, the display control module 107 may describe “Registered path” on the first overhead view image 1211, and “Path suitable for charging” on the second overhead view image 122, and the like.

The message M2 prompts the user to perform an operation of selecting whether to allow the vehicle 1 to perform automated traveling along the travel path 80 or the corrected path 81. In FIG. 9, the message M2 is, for example, “There is path more suitable for charging than registered path. Please select a path to be used for parking and press “Execute” button.” However, the message is not limited to this example. The message M2 may be output as a voice message by the audio output module 108.

The execution button 72 and the cancel button 711 are image buttons with which the user can input an operation.

The execution button 72 enables input of a user's operation of selecting either the travel path 80 or the corrected path 81 and then determining the selected travel path as an execution target. In the example illustrated in FIG. 9, when the first overhead view image 1211 and the second overhead view image 122 function as image buttons. When the user presses the first overhead view image 1211 or the second overhead view image 122, the reception module 101 receives an operation of selecting a path corresponding to the pressed overhead view image.

In addition, the cancel button 711 on the selection screen 21 is an image button enabling input of user's operation of canceling the selection of the path for parking assistance. For example, in a case where the user stops using home zone parking and is going to park by manual driving, the cancel button 711 is pressed by the user.

When the selection screen 20 of the first embodiment described with reference to FIG. 7 is distinguished from the selection screen 21 of the second embodiment illustrated in FIG. 9, the selection screen 20 of the first embodiment may be referred to as a first selection screen 20, and the selection screen 21 of the second embodiment may be referred to as a second selection screen 21.

Next, a flow of correction processing of the travel path 80 executed by the parking assistance device 100 of the present embodiment configured as described above will be described. In the present embodiment, the correction of the travel path 80 is performed at the time of execution of the parking assistance.

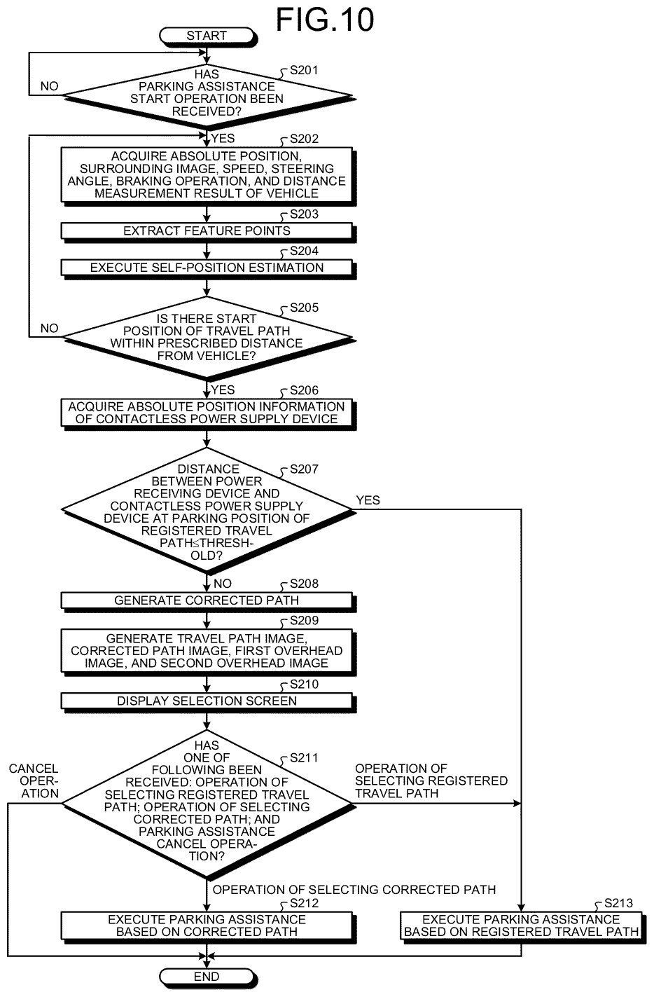

FIG. 10 is a flowchart illustrating an example of a flow of correction processing of the travel path 80 executed by the parking assistance device 100 according to the second embodiment.

First, the reception module 101 determines whether a parking assistance start operation by the user has been received (S201). When the parking assistance start operation by the user has not been received (S201 “No”), the reception module 101 repeats the processing of S201 and waits.

When the reception module 101 has received the parking assistance start operation by the user (S201 “Yes”), the acquisition module 102 acquires the absolute position, the surrounding image, the speed, the steering angle, the braking operation, and the distance measurement result regarding the vehicle 1 (S202).

Subsequently, the extraction module 103 extracts feature points from the plurality of surrounding images acquired (S203).

The estimation module 110 executes self-position estimation processing of estimating the position of the vehicle 1 by comparing the extracted feature points with the feature points of the surrounding image captured by the in-vehicle camera 16 during the teacher traveling (S204). The estimation module 110 may execute self-position estimation processing based on a distance measurement result acquired from the wave transmitter/receiver 15, GPS position information acquired from the GPS device 111, or the like.

Based on the result of the self-position estimation, the estimation module 110 determines whether the start position 90 of the travel path 80 is within a prescribed distance from the vehicle 1 (S205). When the start position 90 of the travel path 80 is not within the prescribed distance from the vehicle 1 (S205 “No”), the processing returns to S202. The prescribed distance is a distance enabling the travel control module 111 to control the vehicle 1 to perform automated traveling and merge into the travel path 80. For example, when the current position of the vehicle 1 is too far from the start position 90, it is difficult for the travel control module 111 to execute automated traveling based on the travel path 80. A specific value of the prescribed distance is not particularly limited. When there is no start position 90 of the travel path 80 within the prescribed distance from the vehicle 1, the display control module 107 may cause the display device 120 to display a screen notifying the absence of the start position 90 of the travel path 80 within the prescribed distance from the vehicle 1 so as to prompt the driver to move the vehicle 1. Furthermore, at this time, the display control module 107 may instruct the user of a movement destination by causing the display device 120 to display an image representing the start position 90.

When the start position 90 of the travel path 80 is within the prescribed distance from the vehicle 1 (S205 “Yes”), the acquisition module 102 acquires information related to the position of the contactless power supply device 50. In the present embodiment, the acquisition module 102 acquires absolute position information of the contactless power supply device 50 (S206).

Subsequently, the correction module 105 determines whether the distance between the power receiving device 30 and the contactless power supply device 50 at the parking position of the registered travel path 80 is a threshold or less (S207).

When the distance between the power receiving device 30 and the contactless power supply device 50 at the parking position of the registered travel path 80 is longer than the threshold (S207 “No”), the correction module 105 corrects the travel path 80 so that the distance between the power receiving device 30 and the contactless power supply device 50 of the vehicle 1 at the parking position is the threshold or less, thereby generating the corrected path 81 (S208).

Subsequently, the image generation module 106 generates the travel path image 800, the corrected path image 810, the first overhead view image 1211, and the second overhead view image 122 (S209).

Subsequently, the display control module 107 causes the display device 120 to display the selection screen 21 (S210).

Subsequently, when the reception module 101 has received the operation of selecting the corrected path 81 by the user on the selection screen 21 (S211 “Operation of selecting corrected path”), the travel control module 111 executes parking assistance based on the corrected path 81 (S212). Specifically, the travel control module 111 controls the vehicle 1 to perform automated traveling to the parking region 92 along the corrected path 81.

When the reception module 101 has received the operation of selecting the travel path 80 by the user on the selection screen 21 (S211 “Operation of selecting registered travel path”), the travel control module 111 executes parking assistance based on the registered travel path 80 stored in the storage unit 150 (S213).

When the reception module 101 has received the operation of canceling the parking assistance by the user on the selection screen 21 (S211 “Cancel operation”), the travel control module 111 ends the processing of this flowchart without executing the parking assistance.

When the distance between the power receiving device 30 and the contactless power supply device 50 at the parking position of the registered travel path 80 is the threshold or less (S207 “Yes”), the correction module 105 does not correct the registered travel path 80. In this case, the process proceeds to S213, and the travel control module 111 executes parking assistance based on the registered travel path 80 stored in the storage unit 150.

In this manner, before the start of the automated traveling of the vehicle 1, the parking assistance device 100 of the present embodiment acquires the information related to the position of the contactless power supply device 50 and corrects the travel path 80 stored in the storage unit 150 based on the information related to the position of the contactless power supply device 50. Therefore, according to the parking assistance device 100 of the present embodiment, in addition to achieving the effects similar to those of the first embodiment, it is also possible to correct the registered travel path 80 in accordance with the positional relationship between the vehicle 1 and the contactless power supply device 50 at the start of automated traveling.

Although the parking assistance device 100 of the present embodiment registers the travel path 80 without correction during the teacher traveling, but the correction processing may be executed both during the teacher traveling and during the execution of the parking assistance. Alternatively, when the user performs the operation of registering the travel path 80 of the teacher traveling on the selection screen 20 displayed by the display control module 107 after the teacher traveling, the display control module 107 may cause the selection screen 21 to be displayed before the start of the automated traveling of the vehicle 1 to reconfirm the intention of the user whether to make a correction.

### First Modification

In the first and second embodiments described above, the path recording module 104 of the parking assistance device 100 records the travel path 80 based on the teacher traveling. However, the method of obtaining the travel path 80 is not limited thereto.

For example, the acquisition module 102 of the parking assistance device 100 may acquire, from another vehicle, the travel path 80 recorded in the other vehicle. Communication with another vehicle may be performed via a network such as the Internet. The communication may be performed between the vehicle 1 equipped with the parking assistance device 100 and another vehicle via a server, using either wired communication or wireless communication. In addition, the acquisition module 102 of the parking assistance device 100 may acquire the travel path 80 recorded in another vehicle from a storage device such as a flash drive.

More specifically, the acquisition module 102 acquires travel path information including time series association of feature points extracted from a plurality of surrounding images captured together with teacher traveling movement of another vehicle that has undergone teacher traveling for recording the travel path 80. The acquisition module 102 may further acquire vehicle size information such as a length, a height, and a width of another vehicle, vehicle type information including a manufacturer and model information of the another vehicle, and performance information indicating vehicle performance including a minimum turning radius of the another vehicle.

The correction module 105 of the present modification may correct the travel path 80 recorded by teacher traveling performed by the driver in another vehicle based on the information related to the position of the contactless power supply device 50 acquired by the acquisition module 102. Alternatively, a correction module of the parking assistance device of another vehicle that has executed the teacher traveling may perform, in the another vehicle, correction of the travel path 80 based on the information related to the position of the contactless power supply device 50.

In addition, the parking assistance device 100 may include a transmission unit that transmits the travel path 80 or the corrected path 81 recorded in the teacher traveling in the vehicle 1 to another vehicle.

For example, in a case where a parking lot is shared by a plurality of vehicles of the same type like business vehicles, it is possible to use a method in which the driver executes teacher traveling in any one of the vehicles and then providing, to other vehicles, the travel path 80 or the corrected path 81 recorded in the teacher traveling, thereby reducing the number of times of execution of teacher traveling.

### Second Modification

In the first and second embodiments described above, the absolute position information indicating the absolute position of the contactless power supply device 50 is described an example of the information related to the position of the contactless power supply device 50. However, the information related to the position of the contactless power supply device 50 is not limited to this information.

For example, the acquisition module 102 of the parking assistance device 100 may acquire a surrounding image obtained by capturing the periphery of the vehicle 1 from the in-vehicle camera 16, and acquire the distance and direction from the vehicle 1 to the contactless power supply device 50 from the surrounding image as the information related to the position of the contactless power supply device 50. Furthermore, in this case, the acquisition module 102 may perform image processing to recognize the mark 51 attached to the contactless power supply device 50 so as to estimate the position of the contactless power supply device 50. According to the present modification, the parking assistance device 100 can specify the positional relationship between the vehicle 1 and the contactless power supply device 50 without acquiring the absolute position such as the latitude and longitude of the contactless power supply device 50. This makes it possible to correct the travel path 80 according to the position of the contactless power supply device 50.

### Third Modification

Alternatively, the acquisition module 102 of the parking assistance device 100 may acquire the relative positional relationship between the feature point around the vehicle 1 extracted by the extraction module 103 and the contactless power supply device 50 as the information related to the position of the contactless power supply device 50. In this case, the acquisition module 102 acquires the position of the contactless power supply device 50 on the map indicating the environment around the vehicle 1 around the parking frame 91. Similarly to the second modification, it is possible, in the present modification, to specify the positional relationship between the vehicle 1 and the contactless power supply device 50 without acquiring the absolute position such as the latitude and longitude of the contactless power supply device 50. This makes it possible to correct the travel path 80 according to the position of the contactless power supply device 50.

### Fourth Modification

In addition, the acquisition module 102 of the parking assistance device 100 may acquire the distance between the vehicle 1 and the contactless power supply device 50 based on a signal strength, that is, a strength of a signal transmitted from the contactless power supply device 50. The signal is supposed to be a signal conforming to a standard such as Wi-Fi (registered trademark) or Bluetooth (registered trademark), but is not limited thereto. In the present modification, the signal strength, specifically, the strength of the signal transmitted from the contactless power supply device 50 is an example of the information related to the position of the contactless power supply device 50.

In this case, the acquisition module 102 of the parking assistance device 100 acquires a signal a plurality of times during the teacher traveling, for example. The acquisition module 102 acquiring the distance between the vehicle 1 and the contactless power supply device 50 based on the signal strength regarding each signal a plurality of times, thereby acquiring a relative positional relationship between the vehicle 1 and the contactless power supply device 50.

Note that two or more of the first/second embodiments, and the second to fourth modifications may be combined. That is, the acquisition module 102 of the parking assistance device 100 may acquire a plurality of pieces of information as information related to the position of the contactless power supply device 50.

### Fifth Modification

In the first and second embodiments described above, the acquisition module 102 of the parking assistance device 100 acquires information related to the position of the contactless power supply device 50 from the contactless power supply device 50. However, the transmission source of the information related to the position of the contactless power supply device 50 is not limited to the contactless power supply device 50.

For example, a tracker-transmitter provided around the parking frame 91 may transmit information related to the position of the contactless power supply device 50. In this case, the acquisition module 102 of the parking assistance device 100 acquires information related to the position of the contactless power supply device 50 from the contactless power supply device 50 from the tracker-transmitter.

### Sixth Modification

Although the first and second embodiments described above uses an example in which the display device 120 in the vehicle 1 is used as a display unit, the display unit is not limited to the display device 120. For example, a display of a tablet terminal or a smartphone (not illustrated) may be used as the display unit. Alternatively, a head-up display that perform projection on the windshield 180 or a transparent plate near the windshield 180 of the vehicle 1 may be used as the display unit.

Furthermore, the operation unit is not limited to the display device 120 or the operation button 141. For example, an operation terminal capable of transmitting a signal to the vehicle 1 from the outside of the vehicle 1, such as a tablet terminal, a smartphone, a remote controller, or an electronic key (not illustrated), may be used as an example of the operation unit. The tablet terminal and the like need not be directly connected to the parking assistance device 100 of the vehicle 1. Data and control signals may be transmitted and received via a server device or a cloud environment.

### Seventh Modification

In addition, some of the functions of the parking assistance device 100 in the first and second embodiments described above may be executed by an information processing device provided outside the vehicle 1. Examples of the information processing device provided outside the vehicle 1 include a mobile terminal such as a smartphone, a PC, and a server device. Note that the information processing device may be provided in a cloud environment. In addition, the functions of the parking assistance device 100 in the first and second embodiments described above may be separately implemented in a plurality of in-vehicle devices.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A parking assistance device comprising:
a memory; and
a processor coupled to the memory and configured to:
record a travel path of a vehicle in teacher traveling performed by a driver;
acquire information related to a position of a contactless power supply device capable of performing contactless power supply to the vehicle;
correct the travel path of the vehicle recorded by the teacher traveling performed by the driver, based on the information related to the position of the contactless power supply device; and
execute automated traveling of the vehicle based on the corrected travel path.

2. The parking assistance device according to claim 1, wherein
the processor is configured to receive, from the contactless power supply device, absolute position information indicating an absolute position of the contactless power supply device, as the information related to the position of the contactless power supply device.

3. The parking assistance device according to claim 1, wherein
the processor is configured to acquire an image obtained by capturing a periphery of the vehicle from a camera provided in the vehicle, and acquire, from the image, a distance and a direction from the vehicle to the contactless power supply device as the information related to the position of the contactless power supply device.

4. The parking assistance device according to claim 1, wherein
the processor is further configured to:
extract a feature point around the vehicle from an image obtained by capturing a periphery of the vehicle by a camera provided in the vehicle or from a result of sensing the periphery of the vehicle by a wave transmitter/receiver that transmits and receives an ultrasonic wave or an electromagnetic wave; and
acquire a relative positional relationship between the feature point around the vehicle and the contactless power supply device as the information related to the position of the contactless power supply device.

5. The parking assistance device according to claim 1, wherein
the processor is configured to:
acquire the information related to the position of the contactless power supply device during the teacher traveling; and
correct, after an end of the teacher traveling, the recorded travel path based on the information related to the position of the contactless power supply device, and store the corrected travel path in the memory.

6. The parking assistance device according to claim 2, wherein
the processor is configured to:
acquire the information related to the position of the contactless power supply device during the teacher traveling; and
correct, after an end of the teacher traveling, the recorded travel path based on the information related to the position of the contactless power supply device, and store the corrected travel path in the memory.

7. The parking assistance device according to claim 3, wherein
the processor is configured to:
acquire the information related to the position of the contactless power supply device during the teacher traveling; and
correct, after an end of the teacher traveling, the recorded travel path based on the information related to the position of the contactless power supply device, and store the corrected travel path in the memory.

8. The parking assistance device according to claim 4, wherein
the processor is configured to:
acquire the information related to the position of the contactless power supply device during the teacher traveling; and
correct, after an end of the teacher traveling, the recorded travel path based on the information related to the position of the contactless power supply device, and store the corrected travel path in the memory.

9. The parking assistance device according to claim 1, wherein
the processor is configured to:
acquire, before starting the automated traveling of the vehicle, the information related to the position of the contactless power supply device; and
correct, before starting the automated traveling of the vehicle, the travel path stored in the memory based on the information related to the position of the contactless power supply device.

10. The parking assistance device according to claim 2, wherein
the processor is configured to:
acquire, before starting the automated traveling of the vehicle, the information related to the position of the contactless power supply device; and
correct, before starting the automated traveling of the vehicle, the travel path stored in the memory based on the information related to the position of the contactless power supply device.

11. The parking assistance device according to claim 3, wherein
the processor is configured to:
acquire, before starting the automated traveling of the vehicle, the information related to the position of the contactless power supply device; and
correct, before starting the automated traveling of the vehicle, the travel path stored in the memory based on the information related to the position of the contactless power supply device.

12. The parking assistance device according to claim 4, wherein
the processor is configured to:
acquire, before starting the automated traveling of the vehicle, the information related to the position of the contactless power supply device; and
correct, before starting the automated traveling of the vehicle, the travel path stored in the memory based on the information related to the position of the contactless power supply device.

13. The parking assistance device according to claim 1, wherein
the processor is configured to correct, when a power receiving device of the vehicle is separated from the contactless power supply device by a distance more than a threshold at a parking position of the travel path in the teacher traveling, the travel path so that a distance between the power receiving device of the vehicle and the contactless power supply device is the threshold or less at the parking position.

14. The parking assistance device according to claim 2, wherein
the processor is configured to correct, when a power receiving device of the vehicle is separated from the contactless power supply device by a distance more than a threshold at a parking position of the travel path in the teacher traveling, the travel path so that a distance between the power receiving device of the vehicle and the contactless power supply device is the threshold or less at the parking position.

15. The parking assistance device according to claim 3, wherein
the processor is configured to correct, when a power receiving device of the vehicle is separated from the contactless power supply device by a distance more than a threshold at a parking position of the travel path in the teacher traveling, the travel path so that a distance between the power receiving device of the vehicle and the contactless power supply device is the threshold or less at the parking position.

16. The parking assistance device according to claim 4, wherein
the processor is configured to correct, when a power receiving device of the vehicle is separated from the contactless power supply device by a distance more than a threshold at a parking position of the travel path in the teacher traveling, the travel path so that a distance between the power receiving device of the vehicle and the contactless power supply device is the threshold or less at the parking position.

17. The parking assistance device according to claim 5, wherein
the processor is further configured to cause a display unit to display a selection screen on which a user is able to select whether to correct the travel path recorded by the teacher traveling based on the information related to the position of the contactless power supply device.

18. The parking assistance device according to claim 9, wherein
the processor is further configured to cause a display unit to display a selection screen on which a user is able to select whether to correct the travel path recorded by the teacher traveling based on the information related to the position of the contactless power supply device.

19. The parking assistance device according to claim 1, wherein
the processor is configured to:
acquire a travel path of teacher traveling in another vehicle; and
correct the acquired travel path based on the information related to the position of the contactless power supply device.

20. A parking assistance method comprising:
recording a travel path of a vehicle in teacher traveling performed by a driver;
acquiring information related to a position of a contactless power supply device capable of performing contactless power supply to the vehicle;
correcting the travel path of the vehicle recorded by the teacher traveling performed by the driver, based on the information related to the position of the contactless power supply device; and
executing automated traveling of the vehicle based on the corrected travel path.
